(19) United States
(12) Patent Application Publication
(10) Pub. No.: US 2012/0288747 A1
(43) Pub. Date: Nov. 15, 2012

(54) ELECTROCHEMICAL DEVICE

(75) Inventors: Masaya Naoi, Sayama-shi (JP); Katsuhiko Hieda, Brussels (BE); Kinji Yamada, Yokkaichi-shi (JP)

(73) Assignee: JSR Corporation, Tokyo (JP)

(21) Appl. No.: 13/519,752

(22) PCT Filed: Jan. 18, 2011
(86) PCT No.: PCT/JP11/50696

§ 371 Date: Jun. 28, 2012

(30) Foreign Application Priority Data
Jan. 29, 2010 (JP) 2010-017666

(51) Int. Cl. H01M 2/02; H01G 9/00; H01M 2/30

(52) U.S. Cl. 429/178; 429/163; 361/500

(57) ABSTRACT

The object of the present invention is to provide an electrochemical device, by which short circuit between electrode sheets can be prevented even when the electrode sheets come into contact with each other due to misregistration upon folding of the electrode sheets.

The electrochemical device of the present invention is an electrochemical device having a electrode unit with a pair of band-like electrode sheets respectively folded so as to be alternately stacked in a state that the following respective electrode layers come into no contact with each other, wherein the pair of the electrode sheets each have a band-like current collector, a plurality of electrode layers respectively formed on plane regions surrounded by peripheral edge portions and folding edge portions in at least one surface of the current collector, and insulating films formed on respective both surfaces of the peripheral edge portions and folding edge portions in the current collector.

### TECHNICAL FIELD

The present invention relates to an electrochemical device such as a lithium ion capacitor or lithium ion secondary battery, and particularly to an electrochemical device having an electrode unit obtained by respectively folding a pair of band-like electrode sheets so as to be alternately stacked through a separator.

### BACKGROUND ART

In recent years, miniaturization and weight saving of electronic equipment have made remarkable progress. With the progress, there has been a higher demand for also miniaturizing and weight-saving a battery used as a power source for driving such electronic equipment. In order to satisfy such a requirement for miniaturization and weight saving, an electrochemical device such as a lithium ion secondary battery has heretofore been developed.

As an electrochemical device meeting uses where high energy density and high power density properties are required, attention is paid to a lithium ion capacitor with the principles of electricity accumulation in the lithium ion secondary battery and the electric double layer capacitor combined.

In the electrochemical device, those having various electrode structures such as a lamination type, a winding type and a folding type are known for the purpose of providing a small-sized and high-capacity device. As the folding type electrochemical device among these, is known a device having an electrode unit obtained by causing a pair of band-like electrode sheets to intersect each other in respective longitudinal directions and folding them zigzag plural times so as to be alternately stacked through a separator (see Patent Literature 1).

However, such a folding type electrochemical device involves such various problems that damage to an electrode layer and falling out of an active material making up the electrode layer occur because large stress is applied to a folded edge of the electrode sheet, and so performance is lowered, and that the thickness of the folded edge of the electrode sheet is larger than that of another portion, and so dimensional accuracy is low.

In order to solve such problems, there has been proposed an electrochemical device with an electrode layer formed in a surface region except for a folded edge of the electrode sheet (see Patent Literature 2).

### CITATION LIST

### Patent Literature

Patent Literature 1: Japanese Utility Model Application Laid-Open No. 4-35351

Patent Literature 2: Japanese Utility Model Publication No. 48-23614

### SUMMARY OF INVENTION

### Technical Problem

However, the above-described electrochemical device involves the following problems.

Since the electrode sheet is small in thickness and hard to handle, it is actually difficult to stack such an electrode sheet with high positional accuracy while being folded. When misregistration between electrode sheets occurs upon folding of the electrode sheets, there is a possibility that the electrode sheets may come into contact with each other to cause short circuit.

In addition, when current collector portions laminated are respectively electrically connected to an electrode terminal by welding or the like, the whole thickness becomes considerably large because a great number of the current collector portions are laminated, and so a distance between, for example, a lower current collector portion and the electrode terminal becomes considerably long, so that energy of welding does often not sufficiently reach the lower current collector portion. Therefore, the current collector portion where the energy of welding does not reach is not surely electrically connected to the electrode terminal. As a result, there is a problem that a contact resistance becomes high.

Since a great number of current collector portion and electrode layers are laminated, there is also a problem that the electrode unit is easy to build up heat.

Since the electrode layer is formed on the current collector overall in a width direction thereof, that is, the electrode layer is formed even at a position on a side peripheral edge portion of the current collector, there is a possibility that electrode layers opposing each other in the respective electrode sheets may come into contact with each other to short-circuit even when a separator is misregistered slightly.

The present invention has been made on the basis of the foregoing circumstances and has as its first object the provision of an electrochemical device with a pair of electrode sheets folded so as to be alternately stacked through a separator, by which short circuit between the electrode sheets can be prevented even when the electrode sheets come into contact with each other due to misregistration upon folding of the electrode sheets.

A second object of the present invention is to provide an electrochemical device that can inhibit build-up of heat in an electrode unit.

A third object of the present invention is to provide an electrochemical device that is low in contact resistance between a current collector and an electrode terminal connected to the current collector.

A fourth object of the present invention is to provide an electrochemical device that can prevent respective electrode layers in electrode sheets from coming into contact with each other to short-circuit even when a separator is misregistered.

### Solution to Problem

According to the present invention, there is provided an electrochemical device comprising an electrode unit with a pair of band-like electrode sheets respectively folded so as to be alternately stacked in a state that the following respective electrode layers come into no contact with each other, wherein
the pair of the electrode sheets each have a band-like current collector, a plurality of electrode layers respectively formed on plane regions surrounded by peripheral edge portions and folding edge portions in at least one surface of the current collector, and insulating films formed on respective both surfaces of the peripheral edge portions and folding edge portions in the current collector.

In the electrochemical device according to the present invention, the electrode unit may preferably be obtained by causing the pair of the electrode sheets to intersect each other in respective longitudinal directions and folding them zigzag plural times so as to be alternately stacked in a state that the respective electrode layers come into no contact with each other.

In addition, an area of each electrode layer of one electrode sheet may preferably be larger than that of an electrode layer of the other electrode sheet which opposes the electrode layer of said one electrode sheet. In such an electrochemical device, an area of the electrode layer of the electrode sheet which becomes a negative electrode may preferably be larger than that of the electrode layer of the electrode sheet which becomes a positive electrode and opposes the electrode layer of the electrode sheet which becomes the negative electrode. The electrode layers may preferably be formed on both surfaces of the current collector.

Further, the plane shape of each of the electrode layers may preferably be a substantial square or rectangle. In particular, the plane shape of each of the electrode layers may preferably be a substantial square or rectangle whose four corners are rounded.

Furthermore, the thickness of each electrode layer may preferably be 10 to 100 μm.

Still further, one or more through-holes may preferably be formed in at least partial regions of the portions of the current collector, on which the electrode layers are formed.

Yet still further, a lead terminal projecting from a side edge of the current collector may preferably be formed at each of the pair of the electrode sheets.

Yet still further, it may be preferable that a plurality of lead terminals projecting from side edges of the current collector are formed at each of the pair of the electrode sheets, and the respective lead terminals are arranged at positions displaced so as not to be superimposed on one another in a stacking direction of the electrode sheet.

Yet still further, an insulating film may preferably be formed on at least a partial region of one surface or both surfaces of the lead terminal.

Yet still further, a hole may preferably be formed in at least a partial region of the folding edge portion of each of the electrode sheets.

Yet still further, an insulating film may preferably be formed on at least a part of an inner wall surface of the hole formed in the folding edge portion of the electrode sheet.

Yet still further, the electrode layer in each of the electrode sheets may preferably be formed in such a manner that a peripheral edge portion thereof is overlapped on the insulating film.

A separator may preferably be arranged between electrode layers opposing each other in the pair of the electrode sheets.

Yet still further, an electrolytic solution may preferably be present between electrode layers opposing each other in the pair of the electrode sheets.

Yet still further, the electrode layers in the electrode sheet which becomes the negative electrode may preferably be doped with a lithium ion.

Yet still further, the electrochemical device may preferably be applied to a lithium ion capacitor.

According to the present invention, there is also provided an electrochemical device obtained by housing an electrode unit with a pair of band-like electrode sheets respectively folded so as to be alternately stacked in a state that the following respective electrode layers come into no contact with each other in an outer container, wherein
the pair of the electrode sheets each have a band-like current collector and an electrode layer formed on at least one surface of the current collector, and
a lead terminal projecting from a side edge of the current collector is formed at each of the pair of the electrode sheets.

In such an electrochemical device, it may be preferable that a plurality of lead terminals projecting from side edges of the current collector are formed at each of the pair of the electrode sheets, and the respective lead terminals are arranged at positions displaced so as not to be superimposed on one another in a stacking direction of the electrode sheet.

According to the present invention, there is further provided an electrochemical device obtained by housing an electrode unit with a pair of band-like electrode sheets respectively folded so as to be alternately stacked in a state that the following respective electrode layers come into no contact with each other in an outer container, wherein
the pair of the electrode sheets each have a band-like current collector and a plurality of electrode layers respectively formed on plane regions surrounded by peripheral edge portions and folding edge portions in at least one surface of the current collector.

In such an electrochemical device, the plane shape of each of the electrode layers may preferably be a rectangle.

### Advantageous Effects of Invention

According to the electrochemical device of the present invention, the insulating films are formed on respective both surfaces of the peripheral edge portions and folding edge portions in the current collector in the electrode sheet, so that short circuit between the electrode sheets can be prevented even when the electrode sheets come into contact with each other due to misregistration upon folding of the electrode sheets.

In addition, according to the construction that the lead terminal or tab projecting from the side edge of the current collector is formed at each of the pair of the electrode sheets, heat generated in the electrode unit is radiated through this tab, so that build-up of heat in the electrode unit can be prevented or inhibited.

Further, according to the construction that the plurality of the lead terminals projecting from the side edges of the current collector are formed at positions displaced so as not to be superimposed on one another in a stacking direction of the electrode sheet, all the lead terminals can be directly connected to an electrode terminal by welding or the like, so that energy is easy to be transmitted upon the welding between the lead terminals and the electrode terminal, whereby electrical connection of the lead terminals to the electrode terminal is surely achieved. As a result, connection failure is hard to occur, it can be prevented that a contact resistance becomes high, and yield can also be improved.

Furthermore, according to the construction that the plurality of the electrode layers are respectively formed on plane regions surrounded by peripheral edge portions and folding edge portions in at least one surface of the current collector, the respective electrode layers in the electrode sheets can be prevented from coming into contact with each other to short-circuit even when the separator is misregistered.

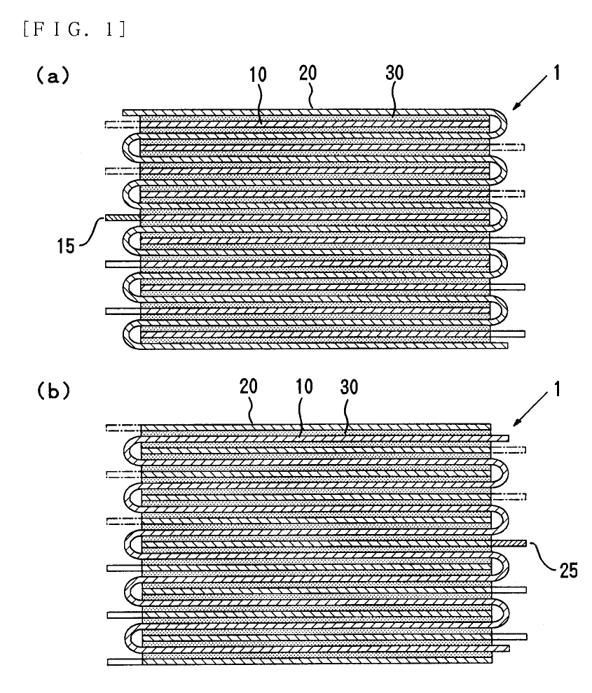

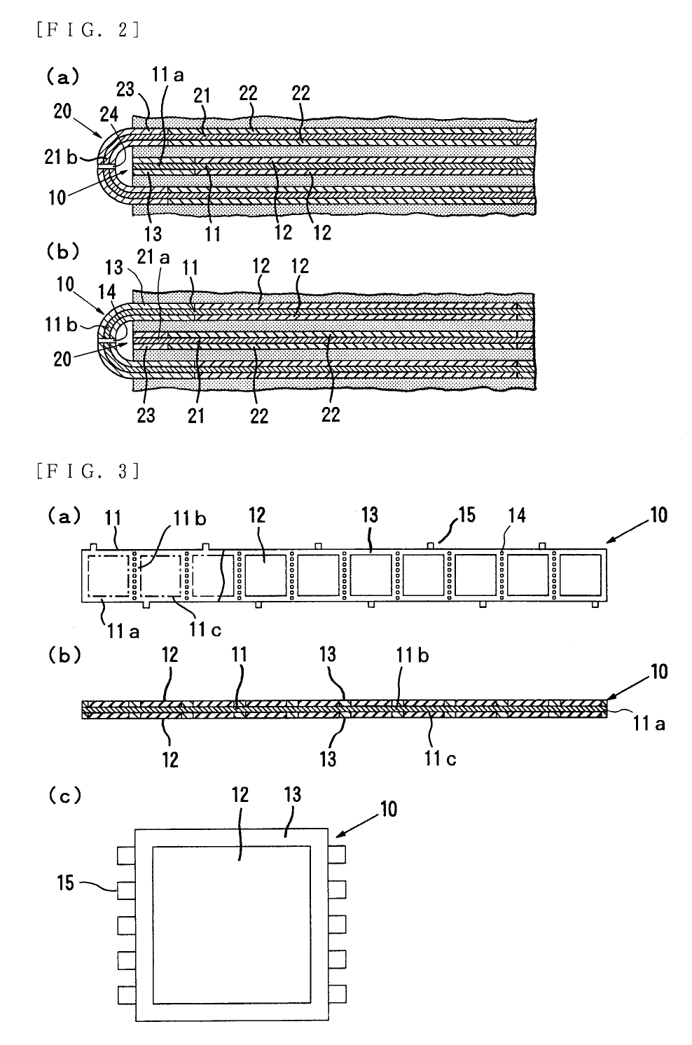

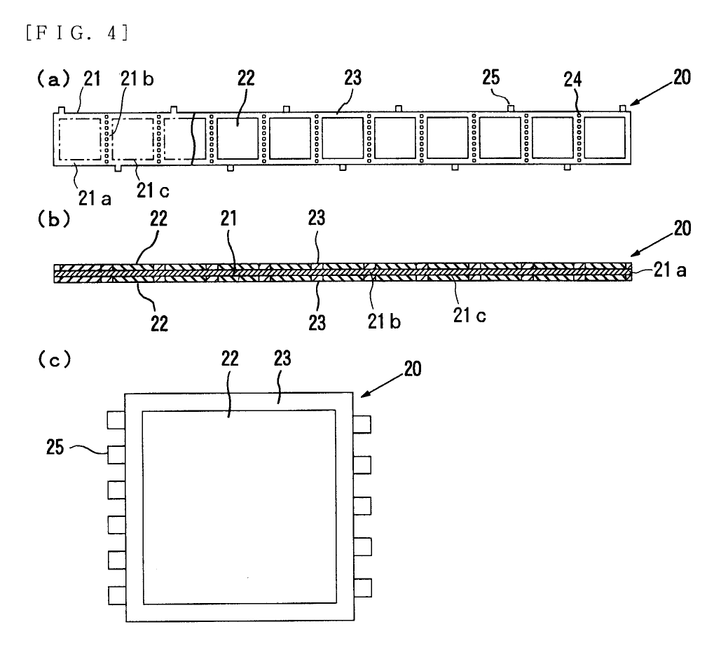

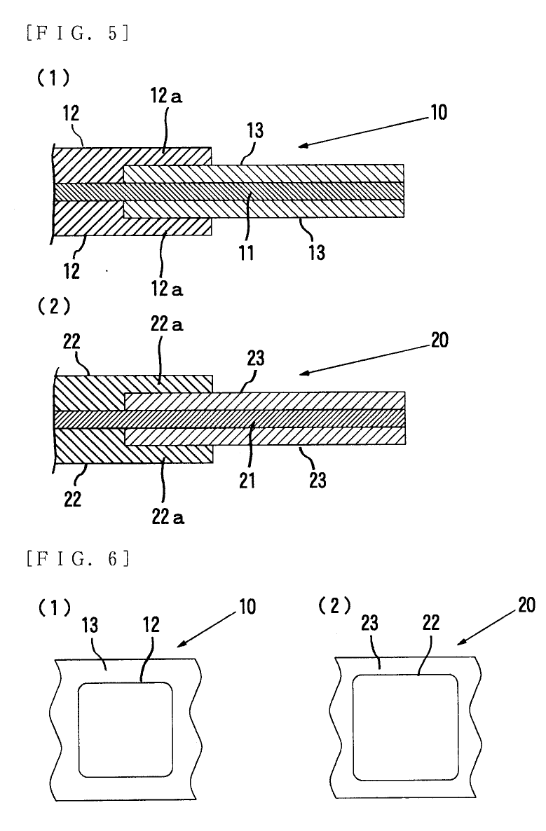

### BRIEF DESCRIPTION OF DRAWINGS

[FIG. 1] is explanatory sectional views schematically illustrating the construction of an electrode unit in an electrochemical device according to an embodiment of the present invention, in which (a) is a cross-sectional view taken along a width direction of a positive electrode sheet, and (b) is a longitudinal sectional view taken along a width direction of a negative electrode sheet.

[FIG. 2] is explanatory sectional views illustrating portions of the electrode unit on an enlarged scale, in which (a) is a cross-sectional view taken along a width direction of the positive electrode sheet, and (b) is a longitudinal sectional view taken along a width direction of the negative electrode sheet.

[FIG. 3] is explanatory views illustrating the construction of the positive electrode sheet, in which (a) is a plan view illustrating the positive electrode sheet in a developed state, (b) is a sectional view illustrating the positive electrode sheet taken along a longitudinal direction in the developed state, and (c) is a plan view illustrating the positive electrode sheet in a folded state.

[FIG. 4] is explanatory views illustrating the construction of the negative electrode sheet, in which (a) is a plan view illustrating the negative electrode sheet in a developed state, (b) is a sectional view illustrating the negative electrode sheet taken along a longitudinal direction in the developed state, and (c) is a plan view illustrating the negative electrode sheet in a folded state.

[FIG. 5] is an explanatory sectional view illustrating, on an enlarged scale, portions of a positive electrode sheet and a negative electrode sheet in an electrochemical device according to another embodiment of the present invention.

[FIG. 6] is a plan view illustrating, on an enlarged scale, electrode layers of a positive electrode sheet and a negative electrode sheet in an electrochemical device according to a further embodiment of the present invention.

### DESCRIPTION OF EMBODIMENTS

Electrochemical devices according to embodiments of the present invention will now be described.

FIG. 1 is explanatory sectional views schematically illustrating the construction of an electrode unit in an electrochemical device according to an embodiment of the present invention, in which (a) is a cross-sectional view taken along a width direction of a positive electrode sheet, and (b) is a longitudinal sectional view taken along a width direction of a negative electrode sheet, and FIG. 2 is explanatory sectional views illustrating portions of the electrode unit on an enlarged scale, in which (a) is a cross-sectional view taken along a width direction of the positive electrode sheet, and (b) is a longitudinal sectional view taken along a width direction of the negative electrode sheet. This electrochemical device is a lithium ion capacitor and is fabricated by housing an electrode unit 1 in an outer container (not illustrated) and filling the container with an electrolytic solution. The electrode unit 1 is fabricated by causing a band-like positive electrode sheet 10 and a band-like negative electrode sheet 20 to intersect each other in respective longitudinal directions and folding them zigzag plural times so as to be alternately stacked through rectangular sheet-like separators 30 in such a manner that electrode layers 12 and 22, which will be described subsequently, come into no contact with each other by the separator.

As also illustrated in FIG. 3, the positive electrode sheet 10 has a band-like positive electrode current collector 11, a plurality of electrode layers 12 containing a positive electrode active material are respectively formed on plane regions 11c surrounded by peripheral edge portions 11a and folding edge portions 11b of the positive electrode current collector 11 in both surfaces of this positive electrode current collector 11, and insulating films 13 are formed on respective both surfaces of the peripheral edge portions 11a and folding edge portions 11b in the positive electrode current collector 11 so as to surround the respective electrode layers 12. The insulating film 13 is preferably also formed on side surfaces of the positive electrode current collector 11. Such an insulating film 13 is formed on the side surfaces of the positive electrode current collector 11, whereby the side surfaces of the positive electrode current collector 11 are prevented from coming into contact with the negative electrode current collector 21 when the positive electrode sheet 10 and the negative electrode sheet 20 are folded zigzag so as to be alternately stacked through the separator 30, so that occurrence of internal short circuit can be surely prevented. From such reasons as described above, the insulating film 13 having a sufficient thickness is preferably surely formed at a corner portion of each folding edge portion 11b in the positive electrode current collector 11.

In addition, a plurality of holes 14 are formed in the positive electrode sheet 10 in a scored state so as to align along a folding edge.

Further, the plane shape of each of the electrode layers 12 in the positive electrode sheet 10 is preferably a substantial rectangle or square.

On the other hand, as also illustrated in FIG. 4, the negative electrode sheet 20 has a band-like negative electrode current collector 21, a plurality of electrode layers 22 containing a negative electrode active material are respectively formed on plane regions 21c surrounded by peripheral edge portions 21a and folding edge portions 21b of the negative electrode current collector 21 in both surfaces of this negative electrode current collector 21, and insulating films 23 are formed on respective both surfaces of the peripheral edge portions 21a and folding edge portions 21b in the negative electrode current collector 21 so as to surround the respective electrode layers 22. The insulating film 23 is preferably also formed on side surfaces of the negative electrode current collector 21. Such an insulating film 23 is formed on the side surfaces of the negative electrode current collector 21, whereby the side surfaces of the negative electrode current collector 21 are prevented from coming into contact with the positive electrode current collector 11 when the positive electrode sheet 10 and the negative electrode sheet 20 are folded zigzag so as to be alternately stacked through the separator 30, so that occurrence of internal short circuit can be surely prevented. From such reasons as described above, the insulating film 23 having a sufficient thickness is preferably surely formed at a corner portion of each folding edge portion 21b in the negative electrode current collector 21.

As described above, the insulating films 13 and the insulating films 23 are respectively formed on the peripheral edge portions 11a of the positive electrode sheet 10 and the peripheral edge portions 21a of the negative electrode sheet 20, whereby the influence of short circuit by pin-holes produced upon the formation of the respective insulating films 13 and 23 can be markedly reduced.

In addition, a plurality of holes 24 are formed in the negative electrode sheet 20 in a scored state so as to align along a folding edge.

Further, the plane shape of each of the electrode layers 22 in the negative electrode sheet 20 is preferably a substantial rectangle or square.

One or more through-holes are preferably formed in at least partial regions of the portions of each of the positive electrode current collector 11 and the negative electrode current collector 21 (both may hereinafter be also referred to as “electrode current collector” collectively), on which the electrode layers 12 and 22, which will be described subsequently, are formed. This through-hole can be formed by, for example, punching or etching. The shape of the through-hole in the electrode current collector may be suitably set to any shape such as a circle, a rectangle or the like. When the shape of the through-hole in the electrode current collector is a circle, etching processability upon the formation of the through-hole becomes high. When the shape of the through-hole in the electrode current collector is a rectangle on the other hand, a slurry can be easily penetrated into the through-hole upon application of the slurry. The electrode current collector, in which such through-holes have been formed, is used, whereby lithium ions can be freely transferred between respective electrodes through the through-holes in the electrode current collector, so that the electrode layers 22 in the negative electrode sheet 20 can be uniformly doped with lithium ions in a short period of time.

The thickness of the electrode current collector is preferably 20 to 50 μm from the viewpoints of strength and weight saving.

With respect to the size of the through-hole in the electrode current collector, the diameter thereof is preferably within a range of 20 μm to 200 μm, and the opening rate of the through-holes is preferably of the order of 20% to 70% when a surface area of one surface of the electrode current collector is regarded as 100%. When the opening rate of the through-holes is within a range of 20% to 70%, an electrochemical device low in resistance and high in doping performance of lithium ions can be obtained.

Various materials generally used in applications such as organic electrolyte batteries may be used as a material of the electrode current collector. Specific examples of the material for the negative electrode current collector 21 include stainless steel, copper and nickel, and examples of the material for the positive electrode current collector 11 include aluminum and stainless steel.

The electrode layers 12 in the positive electrode sheet 10 contain a positive electrode active material capable of reversibly supporting an anion such as, for example, tetrafluoroborate.

As the positive electrode active material making up the electrode layers 12, may be used, for example, active carbon, a conductive polymer or a polyacenic organic semiconductor (hereinafter referred to as “PAS”) which is a heat-treated aromatic condensed polymer having a polyacenic skeleton structure with an atomic ratio (hereinafter referred to as “H/C”) of hydrogen atoms/carbon atoms of 0.05 to 0.50.

The electrode layers 22 in the negative electrode sheet 20 contain a negative electrode active material capable of reversibly supporting lithium ions.

As the negative electrode active material making up the electrode layers 22, may be suitably used, for example, graphite, non-graphitizing carbon or PAS which is a heat-treated aromatic condensed polymer with H/C of 0.50 to 0.05.

In the electrochemical device according to the present invention, the electrode layers 12 or 22 in the positive electrode sheet 10 or the negative electrode sheet 20 are formed on the electrode current collector with a material containing the positive electrode active material or negative electrode active material (both may hereinafter be also referred to as “electrode active material” collectively), and no particular limitation is imposed on a forming method thereof. Any publicly known method may be utilized. For example, a method of applying a slurry containing the electrode active material by means of a method such as a screen printing method, transfer printing method or slit-die coating method may be utilized. Specifically, a slurry with electrode active material powder, a binder and optional conductive powder dispersed in an aqueous medium or organic solvent is prepared, and this slurry is applied to the surface of the electrode current collector and dried, or the slurry is formed into a sheet in advance, and the resultant formed product is stuck on the surface of the electrode current collector, whereby the electrode layers 12 or 22 can be formed.

Here, examples of the binder used in the preparation of the slurry include rubber binders such as SBR, fluorine-containing resins such as polyethylene tetrafluoride and polyvinylidene fluoride, and thermoplastic resins such as polypropylene and polyethylene. Among these, the fluorine-containing resins are preferred as the binder, and a fluorine-containing resin having an atomic ratio (hereinafter referred to as “F/C”) of fluorine atoms/carbon atoms of not lower than 0.75 and lower than 1.5 is particularly preferably used, with a fluorine-containing resin having F/C of not lower than 0.75 and lower than 1.3 being further preferred.

The amount of the binder used is 1 to 20% by mass, preferably 2 to 10% by mass based on the electrode active material though it varies according to the kind of the electrode active material and the shape of the resulting electrode.

Examples of the conductive powder optionally used include acetylene black, graphite and metal powder. The amount of the conductive powder used is preferably 2 to 40% by mass in terms of a proportion based on the electrode active material though it varies according to the electric conductivity of the electrode active material and the shape of the resulting electrode.

When the electrode layers 12 or 22 are formed by applying the slurry to the electrode current collector, a primer layer composed of a conductive material may also be formed on a surface to be coated of the electrode current collector. If the slurry is directly applied to the surface of the electrode current collector, the slurry may be leaked out of the pores in the electrode current collector because the electrode current collector is composed of a porous material, or it may be difficult in some cases to form electrode layers 12 or 22 having a uniform thickness because the surface of the electrode current collector is not smooth. The primer layer is formed on the surface of the electrode current collector, whereby the pores are closed by the primer layer, and a smooth coated surface is formed, so that the slurry is easily applied, and electrode layers 12 or 22 having a uniform thickness can be formed. Press working may be performed after the slurry is applied upon the formation of the electrode layers 12 or 22, whereby electrode layers 12 or 22 having a uniform thickness can be more surely formed.

The thickness of each of the electrode layers 12 and 22 in the positive electrode sheet 10 and the negative electrode sheet 20 is designed with the thicknesses of the respective electrode layers 12 and 22 balanced with one another in such a manner that a sufficient energy density is surely attained in the resulting electrochemical device. However, the thickness is preferably 10 to 100 μm, more preferably 20 to 80 μm from the viewpoints of the power density and energy density of the resulting electrochemical device and industrial productivity.

As a material forming the insulating films 13 and 23 in the positive electrode sheet 10 and the negative electrode sheet 20, may be used a photo-setting resin or thermosetting resin. Specific examples of such a setting resin include those obtained by adding a photo initiator and a crosslinking agent to a base composed of a polyimide, epoxy or acrylic resin material, and those obtained by mixing fine crosslinked rubber particles with these materials for imparting flexibility thereto.

The thickness of each of the insulating films 13 and 23 is, for example, 1 to 20 μm, preferably 2 to 5 μm.

The width of a portion located on the peripheral edge portion 11a or 21a of the electrode current collector in each of the insulating films 13 or 23 is preferably 150 to 800 μm, more preferably 200 to 600 μm though it varies according to the dimensions of the electrode layer 12 or 22.

The width of a portion located on the folding edge portion 11b or 21b of the electrode current collector in each of the insulating films 13 or 23 is preferably 100 to 10,000 μm, more preferably 200 to 7,000 μm though it varies according to the dimensions of the electrode layer 12 or 22.

No particular limitation is imposed on the size, shape and pitch of the holes 14 or 24 formed in each folding edge portion in each of the positive electrode sheet 10 or the negative electrode sheet 20. However, when the holes are formed in the shape of a circle having a diameter of 0.5 mm at a pitch of 2 mm, an electrolytic solution can be smoothly penetrated into between the positive electrode sheet 10 and the negative electrode sheet 20 through the holes 14 and 24 in an electrolytic solution-injecting step upon the production of the electrochemical device. In addition, an insulating film 13 or 23 is preferably formed on an inner wall surface of each of the holes 14 and 24.

In the electrochemical device according to the present invention, an area of any one of the electrode layer 12 of the positive electrode sheet 10 and the electrode layer 22 of the negative electrode sheet 20 which oppose each other through the separator 30 is preferably larger than that of the other electrode layer. In particular, the area of the electrode layer 22 of the negative electrode sheet 20 is preferably larger than that of the electrode layer 12 of the positive electrode sheet 10, which opposes the electrode layer 22 through the separator 30.

According to such construction, the following effects are achieved. That is, it can be prevented the deposition of metal lithium occurs concentratedly on an edge portion of the electrode layer 22 of the negative electrode sheet 20, and short circuit between the positive electrode sheet 10 and the negative electrode sheet 20 by the metal lithium can be prevented.

A plurality of lead terminals (current collection tabs) 15 projecting from side edges of the positive electrode current collector 11 are formed at the positive electrode sheet 10, and a plurality of lead terminals 25 projecting from side edges of the negative electrode current collector 21 are formed at the negative electrode sheet 20. In this embodiment, the respective lead terminals 15 and 25 are provided corresponding to all the electrode layers 12 and 22 in the positive electrode sheet 10 and the negative electrode sheet 20 and formed so as to project from the side edges of the positive electrode current collector 11 and the negative electrode current collector 21 at side positions of the respective electrode layers 12 and 22. Further the respective lead terminals 15 and 25 are arranged at positions displaced so as not to be superimposed on one another in stacking directions of the positive electrode sheet 10 and the negative electrode sheet 20. Incidentally, there is no need that the lead terminals 15 and 25 are formed corresponding to all the electrode layers 12 and 22 in the positive electrode sheet 10 and the negative electrode sheet 20. For example, the lead terminals may be formed at every other electrode layer of the respective electrode layers 12 and 22 in the positive electrode sheet 10 and the negative electrode sheet 20 so as to project from side edges in the same direction.

According to such construction, junction by welding such as resistance welding or ultrasonic welding can be stably formed when the lead terminals 15 and 25 are respectively connected to a positive electrode terminal and a negative electrode terminal in a subsequent assembly step. On the other hand, when plural lead terminals are stacked and welded in a stacking direction, there is an increased possibility that junction failure may occur at intermediate layers.

When a plurality of lead terminals 15 and 25 are formed so as to project from the side edges in the same direction, the projecting directions of the lead terminals 15 and 25 respectively projecting from the positive electrode sheet 10 and the negative electrode sheet 20 are summarized on one side, so that a process for welding thereto the positive electrode terminal and the negative electrode terminal can be simplified, and a material cost may also be reduced.

An insulating film is preferably formed on at least a partial region of one surface of each of the lead terminals 15 and 25. The material and thickness of this insulating film are the same as those of the insulating films 13 and 23 in the positive electrode sheet 10 and the negative electrode sheet 20. When the lead terminals 15 and 25 are resistance-welded, an opening may be formed in a region necessary for welding of the insulating film formed on each lead terminal 15 or 25, and an insulating film may be formed again in the opening after completion of the welding of the lead terminals 15 and 25.

According to such construction, lithium metal can be prevented from depositing on one surface of each of the lead terminals 15 and 25.

Each of the lead terminals 15 formed on the positive electrode current collector 11 is electrically connected to a positive electrode terminal (not illustrated) provided at an outer container by a proper electrically connecting means, and each of the lead terminals 25 formed on the negative electrode current collector 21 is electrically connected to a negative electrode terminal (not illustrated) provided at the outer container by the proper electrically connecting means.

Such positive electrode sheet 10 and negative electrode sheet 20 can be produced in, for example, the following manner.

First, a band-like electrode current collector with lead terminals formed at side edges thereof is prepared. As a method for forming the lead terminals at the electrode current collector, may be used a method of providing an electrode current collector material having a width larger than the intended electrode current collector and subjecting this electrode current collector material to an etching treatment. When holes in the electrode current collector are formed by the etching treatment, the lead terminals can be formed at the same time as a step of forming the holes in the electrode current collector. A metal plate is drawn and cut into a rectangular mesh form at ordinary temperature or pressed, whereby the electrode current collector may also be formed.

A liquid setting resin is then applied to both surfaces of peripheral edge portions and folding edge portions in the electrode current collector and one surfaces of the lead terminals and subjected to a curing treatment, thereby forming insulating films.

A slurry containing an electrode active material and a binder is applied to plane regions surrounded by the insulating films in both surfaces of the electrode current collector and dried, and the resultant coating layers are pressed, thereby forming electrode layers to obtain a positive electrode sheet 10 or a negative electrode sheet 20.

As the separator 30, may be used, for example, a porous material which is durable against an electrolytic solution and a positive electrode active material or a negative electrode active material, has open cells capable of being impregnated with the electrolytic solution and low in electric conductivity.

As a material of the separator 30, may be used cellulose (paper), polyethylene, polypropylene, cellulose/rayon and other publicly known materials. Among these, cellulose (paper) and cellulose/rayon are preferred from the viewpoints of durability and profitability.

The thickness of the separator 30 is, for example, 20 to 50 μm.

It is only necessary for the separator 30 to have an area larger than a surface area of each of the electrode layers 11 and 22 in the positive electrode sheet 10 and the negative electrode sheet 20, and the separator preferably has a size capable of electrically isolating the electrode layers 11 and 22 opposing each other.

As the outer container into which the electrode unit 1 is housed, may be used various containers generally used in batteries or capacitors. For example, a can-type container composed of a metallic material such as iron or aluminum, a metallic material whose inner surface is coated with an insulating coating for preventing short circuit on the inner surface, a ceramic material, a resin material, or a composite material obtained by laminating them, or a film-type container making use of a laminate film obtained by laminating, for example, aluminum and a polymeric material such as nylon or polypropylene may be used.

As the electrolytic solution filled into the outer container, may be used an aprotic organic solvent electrolyte solution of a lithium salt.

No limitation is imposed on the lithium salt making up the electrolyte so far as it can transfer a lithium ion, does not undergo electrolysis even under a high voltage and can cause the lithium ion to stably exist therein, and specific examples thereof include LiClO₄, LiAsF₆, LiBF₄, LiPF₆ and Li (C₂F₅SO₂)₂N.

Specific examples of the aprotic organic solvent include ethylene carbonate, propylene carbonate, dimethyl carbonate, diethyl carbonate, γ-butyrolactone, acetonitrile, dimethoxyethane, tetrahydrofuran, dioxolane, methylene chloride and sulfolane. These aprotic organic solvents may be used either singly or in any combination thereof.

The electrolytic solution is prepared by mixing the above-described electrolyte and solvent in a fully dehydrated state, and the concentration of the electrolyte in the electrolytic solution is preferably at least 0.1 mol/L, more preferably 0.5 to 1.5 mol/L for the purpose of making an internal resistance by the electrolytic solution low.

Such an electrolytic solution is injected so as to exist between electrode layers 12 and 22 opposing each other in the positive electrode sheet 10 and the negative electrode sheet 20.

Such an electrochemical device is obtained by arranging the electrode unit 1 together with a lithium ion source composed of a lithium metal foil into the outer container, conducting a necessary electrically connecting operation and then filling the electrolytic solution into the outer container. Here, the electrode layers 22 in the negative electrode sheet 20 are doped with lithium ions discharged from the lithium ion source by electrochemical contact of the negative electrode layers 22 of the negative electrode sheet 20 with the lithium ion source.

The lithium ion source may be arranged on, for example, the negative electrode sheet 20 forming a top surface and a bottom surface of the electrode unit 1 through a separator.

The thickness of the lithium metal foil making up the lithium ion source is suitably determined in view of the amount of the lithium ion supported in the electrode layers 22 of the negative electrode sheet 20 in advance but is generally 1 to 300 μm, preferably 10 to 300 μm, more preferably 50 to 300 μm.

The lithium ion source is preferably vapor-deposited on, bonded under pressure to or stacked on a sheet-like current collector made of a metal. In such construction, a lead terminal is provided at the current collector, on which the lithium ion source has been bonded under pressure or stacked, whereby the current collector can be electrically connected to the negative electrode sheet 20 or the negative electrode terminal, and doping with the lithium ion can be smoothly conducted. In addition, the lithium ions may also be supported in the electrode layers 22 by incorporating lithium metal into a negative electrode active material layer in advance.

Here, as the current collector, may preferably be used that easy to bond the lithium metal making up the lithium ion source under pressure thereto, more preferably that having a porous structure like the electrode current collector is preferably used in such a manner that a lithium ion passes through as needed. In addition, as the material for the current collector, is preferably used that does not react with lithium metal, such as stainless steel or copper, and the thickness thereof is preferably 10 to 200 μm.

According to the above-described electrochemical device, the insulating films 13 are formed on the respective both surfaces of the peripheral edge portions 11a and 21a and the folding edge portions 11b and 21b in the positive electrode current collector 11 of the positive electrode sheet 10 and the negative electrode current collector 21 of the negative electrode sheet 20, so that short circuit between the positive electrode sheet 10 and the negative electrode sheet 20 can be prevented even when the positive electrode sheet 10 and the negative electrode sheet 20 come into contact with each other due to misregistration upon folding of the positive electrode sheet 10 and the negative electrode sheet 20.

In addition, since the plurality of the holes 14 and 24 are formed along the respective folding edges of the positive electrode sheet 10 and the negative electrode sheet 20, the folding of the positive electrode sheet 10 and the negative electrode sheet 20 is regularly made upon folding thereof, and an electrolytic solution penetrates into between the positive electrode sheet 10 and the negative electrode sheet 20 through the holes 14 and 24 in a subsequent step of filling the electrolytic solution, so that the separator 30 can be easily impregnated with the electrolytic solution.

Further, when an operation that the positive electrode sheet 10 and the negative electrode sheet 20 are folded is conducted by a folding device, the holes 14 and 24 in the positive electrode sheet 10 and the negative electrode sheet 20 can be utilized as alignment marks, or guide pins can also be inserted into the holes 14 and 24 to utilize them as positioning holes.

Furthermore, the lead terminals 15 and 25 projecting from the respective side edges of the positive electrode current collector 11 and the negative electrode current collector 21 are formed at the positive electrode sheet 10 and the negative electrode sheet 20, whereby heat generated in the electrode unit 1 is radiated through these lead terminals 15 and 25, so that build-up of heat in the electrode unit 1 can be prevented or inhibited.

Still further, the plurality of the lead terminals projecting from the side edges of the positive electrode current collector 11 and the negative electrode current collector 21 are formed at positions displaced so as not to be superimposed on one another in stacking directions of the electrode sheets, whereby all the lead terminals 15 and 25 can be directly connected respectively to the positive electrode terminal and the negative electrode terminal by welding or the like, so that energy is easy to be transmitted upon the welding between the lead terminals 15 or 25 and the positive electrode terminal or the negative electrode terminal, whereby electrical connection of the lead terminals 15 or 25 to the positive electrode terminal or the negative electrode terminal is surely achieved. As a result, connection failure is hard to occur, it can be prevented that a contact resistance becomes high, and yield can also be improved.

Furthermore, the plurality of the electrode layers 12 and 22 are respectively formed on the plane regions surrounded by the peripheral edge portions and folding edge portions in respective both surfaces of the positive electrode current collector 11 and the negative electrode current collector 21, whereby the respective electrode layers 12 and 22 in the positive electrode sheet 10 and the negative electrode sheet 20 can be prevented from coming into contact with each other to short-circuit even when the separator 30 is misregistered.

FIG. 5 is an explanatory sectional view illustrating, on an enlarged scale, portions of a positive electrode sheet and a negative electrode sheet in an electrochemical device according to another embodiment of the present invention.

In the electrochemical device of this embodiment, respective electrode layers 12 and 22 in a positive electrode sheet and a negative electrode sheet are formed in such a manner that peripheral edge portions 12a and 22a thereof overlap respective insulating films 13 and 23. Other constructions are the same as those of the electrochemical device illustrated in FIGS. 1 to 4.

No particular limitation is imposed on the width of each of the peripheral edge portions 12a and 22a of the electrode layers 12 and 22, i.e., the width of a region where the electrode layer 12 or 22 overlaps the insulating film 13 or 23. However, the width is preferably at least 100 μm.

The electrode layers 12 and 22 are preferably formed in such a manner that the total thickness of the electrode layer 12 or 22 and the insulating film 13 or 23 in the region where the electrode layer 12 or 22 overlaps the insulating film 13 or 23 becomes equal to the thickness of a portion formed just on an electrode current collector in the electrode layer 12 or 22. According to such construction, the whole surface of the electrode layer 12 or 22 becomes flat, so that stress concentration caused by the fact that a part of the surface of the electrode layer 12 or 22 projects when the electrode unit is housed in the outer container can be avoided.

According to such an electrochemical device, the same effects as in the electrochemical device illustrated in FIGS. 1 to 4 are achieved. In addition, even if a scatter of coating accuracy is caused in the step of applying a slurry containing an electrode active substance upon the production of the electrochemical device, no space is formed between the resulting electrode layer 12 or 22 and the insulating film 13 or 23, whereby the surface of the current collector 11 or 22 can be prevented from being exposed to the electrolytic solution to avoid short circuit between the positive electrode sheet 10 and the negative electrode sheet 20 caused by deposition of metal lithium on the exposed portion of the current collector 11 or 21.

FIG. 6 is a plan view illustrating, on an enlarged scale, electrode layers of a positive electrode sheet and a negative electrode sheet in an electrochemical device according to a further embodiment of the present invention.

In the electrochemical device of this embodiment, the plane shape of each of the electrode layers 12 and 22 in the positive electrode sheet 10 and the negative electrode sheet 20 is formed into a substantially square or rectangular plane shape whose four corners are rounded. Other constructions are the same as those of the electrochemical device illustrated in FIGS. 1 to 4.

According to such an electrochemical device, the generation of a leakage current caused by concentration of an electric field on the four corners of the electrode layer 12 or 22 can be prevented because the plane shape of the electrode layer 12 or 22 is a substantial square or rectangle whose four corners are rounded.

The electrochemical devices according to the present invention have been described above about the case where they are embodied as the lithium ion capacitor. However, the electrochemical devices according to the present invention are not limited to the lithium ion capacitor so far as they have the electrode unit with a pair of electrode sheets respectively folded so as to be alternately stacked through a separator, and may also be suitably applied to other capacitors such as an electric double layer capacitor and batteries such as a lithium ion secondary battery.

In addition, the electrode layers 12 and 22 in the positive electrode sheet 10 and the negative electrode sheet 20 may also be formed on only respective one surfaces of the positive electrode sheet 10 and the negative electrode sheet 20.

### REFERENCE SIGNS LIST

1 Electrode unit

10 Positive electrode sheet

11 Positive electrode current collector

11a Peripheral edge portion

11b Folding edge portion

11c Plane region

12 Electrode layer

12a Peripheral edge portion

13 Insulating film

14 Hole

15 Lead terminal

20 Negative electrode sheet

21 Negative electrode current collector

21a Peripheral edge portion

21b Folding edge portion

21c Plane region

22 Electrode layer

22a Peripheral edge portion

23 Insulating film

24 Hole

25 Lead terminal

30 Separator

1. An electrochemical device obtained by housing an electrode unit with a pair of band-like electrode sheets respectively folded so as to be alternately stacked in a state that the following respective electrode layers come into no contact with each other in an outer container, wherein
the pair of the electrode sheets each have a band-like current collector, a plurality of electrode layers respectively formed on plane regions surrounded by peripheral edge portions and folding edge portions in at least one surface of the current collector, and insulating films formed on respective both surfaces of the peripheral edge portions and folding edge portions in the current collector.

2. The electrochemical device according to claim 1, wherein the electrode unit is obtained by causing the pair of the electrode sheets to intersect each other in respective longitudinal directions and folding them zigzag plural times so as to be alternately stacked in a state that the respective electrode layers come into no contact with each other.

3. The electrochemical device according to claim 1, wherein an area of each electrode layer of one electrode sheet is larger than that of an electrode layer of the other electrode sheet which opposes the electrode layer of said one electrode sheet.

4. The electrochemical device according to claim 3, wherein an area of the electrode layer of the electrode sheet which becomes a negative electrode is larger than that of the electrode layer of the electrode sheet which becomes a positive electrode and opposes the electrode layer of the electrode sheet which becomes the negative electrode.

5. The electrochemical device according to claim 1, wherein the electrode layers are formed on both surfaces of the current collector.

6. The electrochemical device according to claim 1, wherein the plane shape of each of the electrode layers is a substantial square or rectangle.

7. The electrochemical device according to claim 1, wherein the plane shape of each of the electrode layers is a substantial square or rectangle whose four corners are rounded.

8. The electrochemical device according to claim 1, wherein the thickness of each electrode layer is 10 to 100 μm.

9. The electrochemical device according to claim 1, wherein one or more through-holes are formed in at least partial regions of the portions of the current collector, on which the electrode layers are formed.

10. The electrochemical device according to claim 1, wherein a lead terminal projecting from a side edge of the current collector is formed at each of the pair of the electrode sheets.

11. The electrochemical device according to claim 1, wherein a plurality of lead terminals projecting from side edges of the current collector are formed at each of the pair of the electrode sheets, and the respective lead terminals are arranged at positions displaced so as not to be superimposed on one another in a stacking direction of the electrode sheet.

12. The electrochemical device according to claim 10, wherein an insulating film is formed on at least a partial region of one surface or both surfaces of the lead terminal.

13. The electrochemical device according to claim 1, wherein a hole is formed in at least a partial region of the folding edge portion of each of the electrode sheets.

14. The electrochemical device according to claim 13, wherein an insulating film is formed on at least a part of an inner wall surface of the hole formed in the folding edge portion of the electrode sheet.

15. The electrochemical device according to claim 1, wherein the electrode layer in each of the electrode sheets is formed in such a manner that a peripheral edge portion thereof is overlapped on the insulating film.

16. The electrochemical device according to claim 1, wherein a separator is arranged between electrode layers opposing each other in the pair of the electrode sheets.

17. The electrochemical device according to claim 1, wherein an electrolytic solution is present between electrode layers opposing each other in the pair of the electrode sheets.

18. The electrochemical device according to claim 1, wherein the electrode layers in the electrode sheet which becomes the negative electrode are doped with a lithium ion.

19. The electrochemical device according to claim 1, which is applied to a lithium ion capacitor.

20. An electrochemical device obtained by housing an electrode unit with a pair of band-like electrode sheets respectively folded so as to be alternately stacked in a state that the following respective electrode layers come into no contact with each other in an outer container, wherein
the pair of the electrode sheets each have a band-like current collector and an electrode layer formed on at least one surface of the current collector, and
a lead terminal projecting from a side edge of the current collector is formed at each of the pair of the electrode sheets.

21. The electrochemical device according to claim 20, wherein a plurality of lead terminals projecting from side edges of the current collector are formed at each of the pair of the electrode sheets, and the respective lead terminals are arranged at positions displaced so as not to be superimposed on one another in a stacking direction of the electrode sheet.

22. An electrochemical device obtained by housing an electrode unit with a pair of band-like electrode sheets respectively folded so as to be alternately stacked in a state that the following respective electrode layers come into no contact with each other in an outer container, wherein
the pair of the electrode sheets each have a band-like current collector and a plurality of electrode layers respectively formed on plane regions surrounded by peripheral edge portions and folding edge portions in at least one surface of the current collector.

23. The electrochemical device according to claim 22, wherein the plane shape of each of the electrode layers is a rectangle.
